(19) United States
(12) Patent Application Publication
(10) Pub. No.: US 2008/0028824 A1
(43) Pub. Date: Feb. 7, 2008

(54) Calibration Method

(75) Inventors: Torgny Brogardh, Vasteras (SE); Peter Fixell, Vasteras (SE); Niklas Durinder, Vasteras (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 11/667,480

(22) PCT Filed: Oct. 21, 2005
(86) PCT No.: PCT/SE05/01578

§ 371 Date: May 10, 2007

(30) Foreign Application Priority Data
Nov. 10, 2004 (SE) 0402750-4

(51) Int. Cl. G12B 13/00

(52) U.S. Cl. 73/1.75

(57) ABSTRACT

A method for calibration of an industrial robot having a plurality of sections movably connected to each other for rotation about a plurality of movement axes. An angle measuring member is mounted on the robot so that it measures angular changes of the axis or axes to be calibrated, relative to a vertical line. A reference direction is measured. At least one of the axes is selected as a calibration axis and another of the axes is selected as a measuring axis. The robot is moved between at least two calibration positions. The moving includes rotating the robot about the measuring axis. The calibration positions are selected such that the direction of the calibration axis differs from the vertical line. Angular values are read from the angle measuring member in the calibration positions. The calibration axis are calibrated based on the angular values and the measured reference direction.

### FIELD OF THE INVENTION AND PRIOR ART

The present invention relates to a method for calibration of an industrial robot according to the preamble of claim 1.

An industrial robot can be viewed as a cinematic chain of sections movably connected to each other about a plurality of rotational axis. The first section in the chain is the base of the robot and the last section usually constitutes a tool attachment. The axis are numbered after their position in the cinematic chain, i.e. the first axis in the chain is denoted the first axis, the next axis is denoted the second axis and so on. For the possibility to determine the position of the robot, each axis usually is provided with an angle-measuring device in the form of an encoder or a resolver indicating the position of the axis relative to a zero position. Before an industrial robot can be used it must be calibrated, which means that each of the angle-measuring devices is calibrated with reference to the zero position. The robot is calibrated in the production plant before it is delivered and sometimes on site before being set to work. Thereafter, the robot is calibrated after larger repairs such as motor or arm changes or after collisions. During calibration the correct cinematic position, denoted the home position, of the robot is identified. When the robot is in its home position all axes are in their zero position and thus the angular values from the encoders/resolvers are zero or a reference value.

In the prior art it is known to use an inclinometer, or some other type of instrument for measuring the inclination, to calibrate the robot. An inclinometer measures the angle between an object and the vertical line and is, for example, an electronic spirit level. A calibration device including at least one inclinometer is placed on a plane of reference on one of the sections, and generates a signal, which is a measure of the angle between the plane of reference of the section and the vertical line. Thereafter, the axis is moved in dependence of the generated signal until it has a predetermined angle relative to the vertical line. The other axes are calibrated in the same way by means of further reference planes. Such a calibration method is for example disclosed in the patent document U.S. Pat. No. 5,239,855 and in the international patent application WO02/084216.

In order to obtain a high accuracy of the calibration, the planes of reference must be accurately machined to a high degree of flatness. A disadvantage with this method is that the accuracy of the calibration depends on the accuracy of the planes of reference and the mounting of the calibration device on the plane of reference. For example waste material on the reference surface or imperfections in the machining of the surface may cause an angular error leading to a calibration error. For calibration with the calibration device mounted on the tool attachment there is a large influence on the calibration result due to the small reference surface on the edge of the tool flange. For this mounting position there is also a large influence of the housing of the calibration device on the calibration, which leads to differences between production and field calibrations.

### OBJECTS AND SUMMARY OF THE INVENTION

The object of the present invention is to provide an improved calibration method, which minimizes the influence from the mounting of the calibration device on the robot.

This object is achieved by a method as defined in claim 1. According to the invention an axis is calibrated based on angular measurements in two or more calibration positions. In the following the axis to be calibrated is called the calibration axis. The vertical line is defined as the line of gravity. The reference direction is either the direction of a fixed reference or the direction of an axis earlier in the cinematic chain. The measuring axis is selected as one of the robot axes and it is used for rotating the robot between the calibration positions during calibration of the calibration axis. The measuring axis should be selected such that the direction of the measuring axis reflects the misalignment of the calibration axis. This method differs from the previously described prior art method, in that the axis is calibrated based on the relation between an axis and the vertical line, instead of based on the relation between the mounting plane of the measuring member and the vertical line. Tanks to the fact that the calibration is performed based on the relation between an axis and the vertical line, instead of based on the relation between the mounting plane of the measuring member and the vertical line; the mounting error of the measuring member is eliminated.

The invention minimizes the mechanical influence on the calibration result. This is needed in order to facilitate a 100% repeatable robot position in field with the goal to eliminate program updates and to keep absolute accuracy performance. Mechanical influence can be divided into two groups. The first group will cause errors between the correct kinematic robot position and the actual robot position. This deviation is built into the robot, for example due to manufacturing tolerances, and will be repeated every calibration. The result of having cinematic errors is that the robot behavior will not be as correct as possible. The second group of mechanical influence will cause errors related to different sets of calibration equipment. Differences in this area will cause errors in the robot positioning when updating the robot in field after repair. The method according to the invention minimizes the influence on the calibration result for the first as well as the second group of mechanical influence.

A further advantage with the invention is that the reference planes used in the prior art for calibration of the third and forth axis can be removed since it doesn't have any function with the method according to the invention. Another advantage gained is that the tolerance for manufacturing the reference plane and the calibration equipment are reduced. Another advantage with the invention is that the calibration of the fifth axis can be made independent of the position of the third axis. The invention also facilitates the calibration of axes three, four, five and six without dismounting the angle measuring member and by this not introducing other measuring error.

The method according to the invention is applicable on any calibration equipment using a water leveling device, electronic as well as mechanical.

According to an embodiment of the invention the method comprises calculating the direction of the measuring axis based on said angular values, identifying the misalignment of the calibration axis based on the direction of the measuring axis and on basis thereof calibrating the calibration axis. The measuring axis should be selected such that the direction of the measuring axis reflects of the misalignment of the calibration axis. The calibration positions are selected so that it is possible to calculate the direction of the measuring axis based on the angular measurements in the calibration positions. Accordingly, it is possible to calculate the misalignment of the calibration axis based on the measured angular values.

According to an embodiment of the invention two calibration positions are selected and the direction of the measuring axis is calculated as the difference between the angular values divided by two. The two calibration positions are selected so that the measuring axis is rotated 180 degrees between the two positions. This is advantageous since it facilitates the mathematics needed for the calibration. However, the invention can be used for any rotation when combined with transformation onto the plane of calculation. p According to an embodiment of the invention the method comprises calculating the measuring error of the angular measuring member based on said angular values. The measuring error is the sum of the mounting error and the sensor offset. The calibration positions are selected such that the measuring error depends on the relation between the angular values. Thus, it is possible to calculate the measuring error based on the angular measurements in the calibration positions.

According to an embodiment of the invention two calibration positions are selected and the measuring error of the angular measuring member is calculated as the sum of the angular values divided by two. The measuring axis is rotated 180 degrees between the two positions. This is advantageous since it facilitates the mathematics needed for the calibration. However, the invention can be used for any rotation when combined with transformation onto the plane of calculation.

According to an embodiment of the invention the method comprises selecting a second calibration axis, selecting a reference axis to the second calibration axis, moving the robot to its home position, and calibrating the second calibration axis based on said calculated measuring error and the reference direction of the second calibration axis. This embodiment eliminates the need of a separate reference plane for the third axis and all calibration can be made without moving the angular measuring member.

According to an embodiment of the invention the method comprises selecting a second calibration axis, selecting a reference axis to the second calibration axis, moving the robot to a new calibration position, reading a new angular value from the angle measuring member in said new calibration position, and calibrating the second calibration axis based on the new angular value, said calculated measuring error and the reference direction of the second calibration axis.

According to an embodiment of the invention the calibration positions are selected such that, provided that the angle measuring member is ideal and correctly mounted on the robot and that the robot is an ideal robot, the angle measuring member should produce the same angular value, or angular values that differs with a predefined amount, in the calibration positions. If there is a misalignment of the calibration axis, the position of the angle measuring member, and thus the angle measurement, will change between the calibration positions, otherwise the position of the angle measuring member will remain the same.

According to an embodiment of the invention the robot comprises three successive axes including a rear, an intermediate and a fore axes, wherein the intermediate axis is arranged non-parallel to the rear and fore axis, and the method comprises selecting the intermediate axis as the calibration axis, the fore axis as the measuring axis, and the rear axis as the reference direction, moving the robot to a first calibration position, reading a first angular value from the angle measuring member, moving the robot to a second calibration position, including rotating it about the fore axis, reading a second angular value from the angle measuring member, and calibrating the intermediate axis based on said first and second angular value and the reference direction. For example, the robot includes six axes and said rear axis corresponds to the fourth axis of the six-axes robot, said intermediate axis corresponds to the fifth axis of the six-axes robot, and said fore axis corresponds to the sixth axis of the six-axes robot.

According to another embodiment of the invention the robot comprises three successive axes including a rear, an intermediate and a fore axes, wherein the intermediate axis is arranged non-parallel to the rear and fore axis, and the method comprises selecting the intermediate and rear axis as the calibration axes and the fore axis as the measuring axis, moving the robot to a first calibration position, reading a first angular value from the angle measuring member, moving the robot to a second calibration position, including rotating the robot about the fore axis, reading a second angular value from the angle measuring member, and calibrating the rear and intermediate axes based on said first and second angular value, and the measured reference direction. For example, the robot includes six axes and said rear axis corresponds to the third axis of the six-axes robot, said intermediate axis corresponds to the fourth axis of the six-axes robot, and said fore axis corresponds to the fifth axis of the six-axes robot. According to this embodiment of the invention the rear, and intermediate axis are calibrated based on only two angular measurements. This embodiment and the previous can be combined for all three calibrations without dismounting the angular measuring member.

According to an embodiment of the invention robot comprises a tool attachment mounted rotatable about an tool axis and the angular measuring member is mounted on the tool attachment, wherein the method comprises before reading at least some of the angular values moving the robot about the tool axis so that the angular measuring member is brought into its measuring position. This embodiment makes it possible to carry out all necessary measurements without having to dismount the angular measuring member and reorientate it between the measurements.

According to an aspect of the invention, the object is achieved by a computer program directly loadable into the internal memory of a computer or a processor, comprising software code portions for performing the steps of the method according to the invention, when said program is run on a computer. The computer program is for example provided on a computer readable medium or through a network.

According to another aspect of the invention, the object is achieved by a computer readable medium having a program recorded thereon, when the program is to make a computer perform the steps of the method according to the invention, and said program is run on the computer.

Another object of the present invention is to provide a system for automatic calibration of an industrial robot, which minimizes the influence from the mounting of the calibration equipment on the robot. This object is achieved by a system defined by claim 24. It is easy to realize that the method according to the invention, as defined in the appending set of method claims, is suitable for being executed by an automatic calibration system. Even though not explicitly expressed in the claims, the invention covers a system adapted for carrying out the method according to the appended method claims.

A calibration method according to the invention is useful for calibration of an industrial robot having six axes, as well as for calibration of a robot having any other number of axes.

### BRIEF DESCRIPTION OF THE DRAWINGS

The invention will now be explained more closely by the description of different embodiments of the invention and with reference to the appended figures.

FIG. 1 shows an industrial robot in its home position and an angular measuring member mounted on the robot.

FIG. 2 shows the basic principle for the method according to the invention.

FIG. 3 shows a side view of an example of a first calibration position for the robot.

FIG. 4 shows a side view of an example of a second calibration position for the robot.

FIG. 5 shows in a view from above of an example of a third calibration position for the robot.

FIG. 6 shows in a view from above an example of a fourth calibration position for the robot.

FIG. 7a shows a further example of a calibration position in a side view.

FIG. 7b shows an example of three different calibration positions seen from above.

### DETAILED DESCRIPTION OF PREFERRED EMBODIMENTS OF THE INVENTION

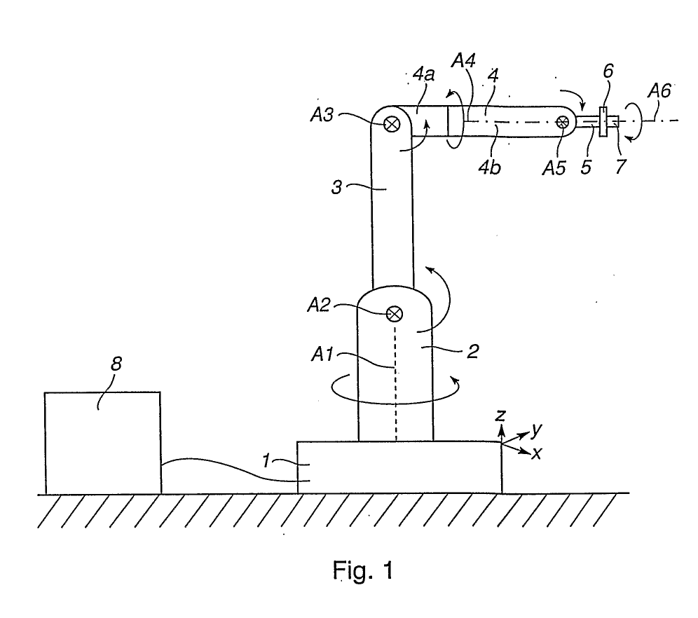

FIG. 1 shows an example of a 6-axis industrial robot standing in a traditional calibration position, also denoted the home position of the robot. The robot comprises a base 1, which is firmly mounted on a foundation. The robot further comprises a stand 2, which is rotatable relative to the base 1 around a first vertical axis A1. In the top end of the stand 2, a first robot arm 3, is rotatably mounted about a second horizontal axis A2. In the outer end of the first arm 3, a second arm 4 is rotatably mounted relative to the first arm about a third axis A3. The second robot arm 4 comprises two parts, 4a and 4b, and the outer part 4b being rotatable relative to the inner part 4a around a fourth axis A4 coinciding with the longitudinal axis of the second arm 4. In its outer end, the second arm 4 supports a so-called robot hand 5, which is rotatable about a fifth axis A5, which is perpendicular to the length axis of the second arm 4. The robot also comprises a tool attachment 6 in the form of a tool plate. The outer part of the robot hand with the tool attachment 6, is rotatable relative to the inner part of the robot hand about a sixth axis A6.

When the robot is in its home position, as shown in FIG. 1, the first axis A1 is essentially parallel with the vertical line. The second axis A2, the third axis A3 and the fifth axis A5 are essentially parallel to each other and essentially perpendicular to the first axis A1, i.e. perpendicular to the vertical line. The fourth axis A4 and the sixth axis A6 are essentially parallel with each other and also perpendicular to the vertical line. A base coordinate system XYZ is defined for the robot. For each of the axes of the robot, there is a level indicator giving a signal, which is a measure of the present rotational angle of the axis. The output signal from the level indicator is transmitted to a control system 8 of the robot.

In FIG. 1, an angular measuring member 7 is mounted on the tool plate 6. The angular measuring member measures the angle between a measuring line and the vertical line. The angular measuring member is for example an electronic or mechanical water levelling device, such as an inclinometer. For example a

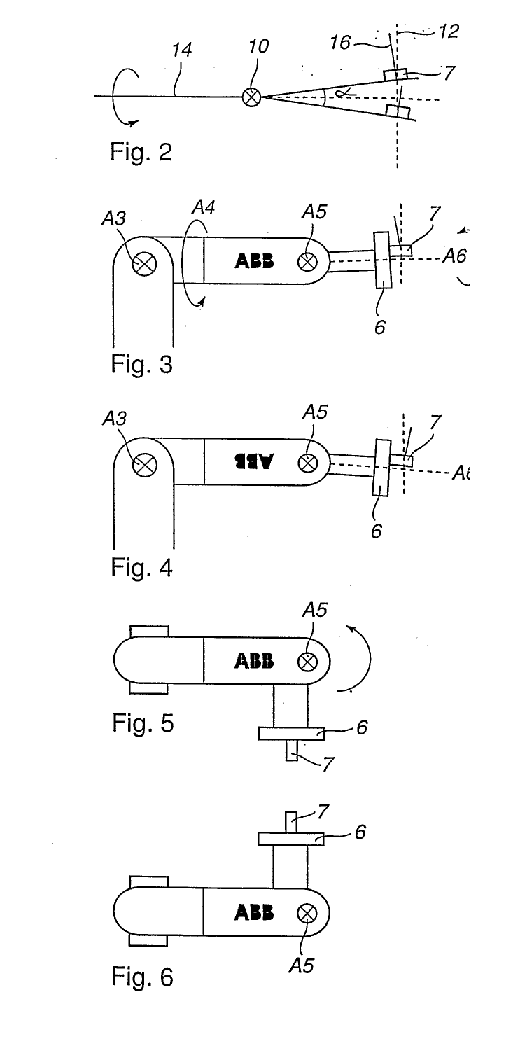

Wyler sensor is suitable as angular measuring member. The basic principals of the method according to the invention will now be discussed in relation to FIG. 2. According to the invention a measuring axis is selected for calibration of a particular axis. For a particular axis there is often more than one alternative for the measuring axis. For example, when axis A5 is to be calibrated it is possible to select between axis A4 and A6 as the measuring axis, when axis A4 is to be calibrated it is possible to select between axis A5 and A6 as the measuring axis, and when axis A3 is to be calibrated it is possible to select between axis A5 and A6 as the measuring axis.

Further a reference axis is selected, which is used as a reference during the calibration. Different reference axis can be used during the calibration. The reference axis is either a fixed reference, for example the normal to a reference plane of the robot, or one of the robot axes. For example axis A1 or A4 is suitable as the reference axis. The calibration axis should be positioned after the reference axis in the kinematic chain of the robot. The direction of the measuring axis relative to the direction of the reference axis is measured and used for providing the calibration axis with a calibration position. In order to measure the direction of the measuring axis, it is rotated between at least two angels and the angle measuring device is read for those angels. The measuring axis should be selected such that the direction of the measuring axis reflects of the misalignment of the calibration axis.

During the calibration, the calibration axis has to be positioned in a direction that differs from the vertical line. The best accuracy is obtained when the calibration axis is perpendicular to the vertical line, but this is not necessary. In the example shown in FIG. 2, an axis 10 is selected as the calibration axis and an axis 14 is selected as the measuring axis. The calibration axis 10 is perpendicular to the vertical line 12. The measuring axis 14 is perpendicular to the vertical line and to the calibration axis 10. An angle measuring member 7 is mounted on the robot so that it measures angular changes of the calibration axis 10 relative to the vertical line 12. The angle measurements from the measuring member correspond to the angle between the measuring axis 16 of the member 7 and the vertical line 12. According to the invention the measuring axis 14 is rotated between at least two angular positions.

The angular positions used for the calibration are selected such that the angle measuring member 7 member is ideal and should provide the same angular value in both positions if the measuring member is correctly mounted on the robot and if the calibration axis is correctly positioned. As shown in FIG. 2 the position of the angle measuring member has been changed during the rotation, and accordingly the angular values m1, m2 from the angle measuring member will differ between the calibration positions, which means that there exists a calibration error. The calibration axis is calibrated by adjusting it so that it obtains a predefined calibration angle, which usually is zero. An angle α is calculated as the difference between the angular values m1, m2 in the calibration positions. The calibration error for the calibration axis 10 is the difference between the angular measurements in the calibration positions divided by two, i.e. α/2=(m1−m2)/2. Thus, the calibration axis should be adjusted with the amount α/2.

In the following it will be shown by way of an example how the general principle explained above can be used for calibration of a robot having six axes. However, the invention is not limited to a six axes robot, in the opposite the general method is also applicable for robots having various numbers of axes.

It is possible to calibrate all axes, except axis A6, with the method according to the invention, but is not always practical. Preferably, calibrations of axis A1, A2 and A6 are performed by any of the prior art calibration methods known as such. Even though it for example is possible to calibrate axis A2 with the method according to the invention, it is not practical since it requires that axis A1 is rotated 180 degrees and the space needed to performing this rotation is normally not available. During calibration of the first axis A1 reference angles from the base are read and stored in the control system of the robot. Preferably, the calculations performed during the entire calibration are performed in the control system of the robot. Thereafter, the control system orders the axes being calibrated to move in dependence of the calculated adjustments value until the axis ends up in its predetermined zero position. As an alternative the identified calibration angles can be used directly without moving the robot.

During calibration of axes A3, A4, A5 and A6 the angular measuring member 7 is attached to the tool attachment 6. The method according to an embodiment of the invention will be described with reference to FIGS. 3-6.

FIG. 3 illustrates calibration of axis A5. At the beginning of the calibration the robot is moved to a rough calibration position, i.e. a position close to the home position. The rough calibration position should preferably be within 5 degrees from the actual home position. At wider angles, the angle measuring member may not work properly. FIG. 3 shows the robot in a first calibration position A. Axis A5 is selected as the calibration axis and axis A4 is selected as the measuring axis. A first angular value a is read from the measuring member 7 when the robot is in the first calibration position A. Thereafter the robot is moved to a second calibration position B as showed in FIG. 4. When changing from the first A to the second B calibration position axis A4 is turned 180 degrees and axis A6 is counter rotated 180 degrees so that it is possible to use the same position of measuring member for measuring the new angular position.

As seen from FIG. 3 and 4, the angular measuring member 7 has a slightly changed position due to misalignment of axis A5. A second value b is read from the measuring member with the robot in the second calibration position B. The readings a and b shall be made in the XY-plane of the base coordinate system of the robot. Thereafter the misalignment of axis A5 is calculated as the difference between the measured angular values divided by 2, i.e. [(a−b)/2]. The amount the axis A5 should be adjusted to obtain a zero position is calculated as [a−(a−b)/2] and axis A5 is moved accordingly.

Calibration of axis A3 and A4 will now be discussed in relation to FIG. 5 and FIG. 6. With the angular measuring member 7 still mounted on the tool plate, the robot is moved to a third calibration position C, as shown in FIG. 5, by turning axis A4 90 degrees and counter rotating axis A6 90 degrees. In this embodiment there are two calibration axes, axis A3 and A4, and axis A5 is selected as the measuring axis. In the third calibration position C axis A5 is essentially vertical. Thereafter, axis A5 is moved 90 degrees. The robot will now have the calibration positions shown in FIG. 5. In this position a third angular value c is read from the angular measuring member. The robot is then moved into a fourth calibration position D, as shown in FIG. 6, by moving axis A5 180 degrees. In the fourth calibration position D a fourth angular value d is read from the angular measuring member. The readings shall be made in the XY plane of the base coordinate system of the robot.

The average of the readings (c−d)/2, wherein d is measured turned 180 degrees, shall be equal to the reference value measured on the base, i.e. the base reference of the robot. The difference between the base reference and the average of the reading is the misalignment of axis A4. This information is used for correction of axis A4. Accordingly, axis A4 is adjusted based on the difference between the base reference and the average reading, i.e. [base ref−(c−d)/2]. After repositioning for reading c, axis A4 of the robot is moved to the value [c+base ref−(c−d)/2].

The misalignment in the mounting of the angular measuring member on the tool plate is calculated as the sum of the readings c and d divided by 2, i.e. [(c+d)/2], wherein d is measured turned 180 degrees. Axis A4, axis A5 and axis A6 are rotated back to the home position. Axis A3 is then calibrated based on the calculated misalignment of the angular measuring member, i.e. based on [(c+d)/2]. Axis A3 is moved to a new value, which is calculated as the base reference value, adjusted for the misalignment of the angular measuring member [(c+d)/2], and is now corrected. Thus, axes A3, A4 and A5 have been calibrated based on only four measurements.

The method according to the invention is suitable for being automatically executed by a computer program having instructions corresponding to the steps in the inventive method when run on a processor unit, for example in the control system of the robot. The operator mounts the angle measuring member on the tool plate. The software produces control signals moving the robot to the calibration positions. The control system receives measurement signals from the angular measuring member and calculates the adjustments necessary in order to calibrate the axis. The software produces control signals to the robot based on the calculated adjustments. The robot is moved in accordance with the received control signals until the axis is in its correct position. The control system of the robot comprises necessary equipments, such as a processor, memory, and other units for running the software, which performs the calibration.

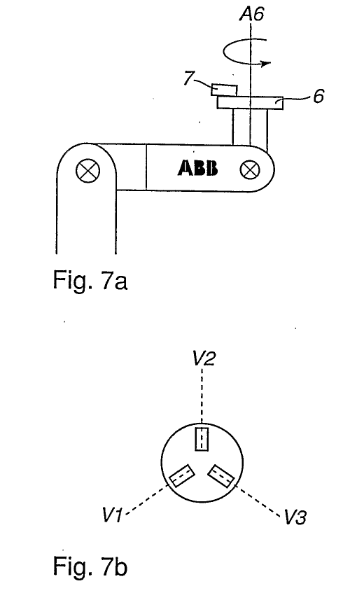

There are many possibilities to implement the invention for calibration of the axes A3, A4, A5. For example axes A4 and A5 can be calculated by rotating axis A6 between three calibration positions V1, V2 and V3, as shown in FIG. 7a and 7b. Axis 6 is then rotated 120 degrees between the three calibration positions, and three angular values v1, v2 and v3 are read for the three positions. Axis A4 and A5 is calibrated based on the three angular measurements. For any other choice of calibration positions more than two positions with other angle difference than 180 degree, the angular values from the angular measuring member need to be recalculated (projected) on a plane to identify the position of the calibration axis.

The present invention is not limited to the embodiments disclosed but may be varied and modified within the scope of the following claims. For example it should be noted that the steps of the invention could be performed in a sequence different from them disclosed in the previous embodiment examples. In particular the sequence of the steps in the claim could as well be performed in another order to achieve the object of the invention. In the previously described example, the sequence in which the axes are calibrated is A5, A4, A3. However, it is also possible to calibrate the axes for example in the sequence A4, A5, A3. In order to achieve a high accuracy axis A5 should preferably be calibrated before axis A3. It is also possible to perform all the measuring before executing the calibration of the axis.

1. A method for calibration of an industrial robot (having a plurality of sections movably connected to each other for rotation about a plurality of movement axes, wherein an angle measuring member is mounted on the robot so that it measures angular changes of the axis or axes to be calibrated, relative to a vertical line, the method comprising:
measuring a reference direction,
selecting at least one of said axes as a calibration axis and another of said axes as a measuring axis,
moving the robot between at least two calibration positions, wherein the moving includes rotating the robot about the measuring axis, and the calibration positions are selected such that the direction of the calibration axis differs from the vertical line,
reading angular values from the angle measuring member in said calibration positions, and
calibrating the calibration axis based on said angular values and the measured reference direction.

2. The method according to claim 1, further comprising:
calculating the direction of the measuring axis based on said angular values, and
identifying the misalignment of the calibration axis based on the direction of the measuring axis and on a basis thereof calibrating the calibration axis.

3. The method according to claim 2, wherein the robot is moved between two calibration positions by rotating the measuring axis rotated 180 degrees and the direction of the measuring axis is calculated based on the difference between the angular values measured in said two calibration positions divided by two ((|a|−|b|)/2).

4. The method according to claim 1, further comprising:
calculating the measuring error of the angular measuring member based on said angular values.

5. The method according to claim 4, wherein the robot is moved between two calibration positions by rotating the measuring axis 180 degrees and the measuring error of the angular measuring member is calculated based on the sum of the angular values measured in said two calibration positions divided by two ((|a|+|b|)/2).

6. The method according to claim 4, further comprising:
selecting a second calibration axis,
selecting a reference axis to the second calibration axis,
moving the robot to a new calibration position,
reading a new angular value from the angle measuring member in said new calibration position, and
calibrating the second calibration axis based on the new angular value, said calculated measuring error and the reference direction of the second calibration axis.

7. The method according to claim 1, wherein the calibration positions are selected such that, provided that the angle measuring member is ideal and correctly mounted on the robot and that the robot is an ideal robot, the angle measuring member should produce the same angular value, or angular values that differs with a predefined amount, in the calibration positions.

8. The method according to claim 1, wherein the robot comprises three successive axes including a rear, an intermediate and a fore axes, wherein the intermediate axis is arranged non-parallel to the rear and the fore axis, the method further comprising:
selecting the intermediate axis as the calibration axis, the fore axis as the measuring axis, and the rear axis as the reference direction,
moving the robot to a first calibration position (A),
reading a first angular value (a) from the angle measuring member,
moving the robot to a second calibration position (B), including rotating it about the fore axis,
reading a second angular value (b) from the angle measuring member, and
calibrating the intermediate axis based on said first (a) and second (b) angular value and the reference direction.

9. The method according to claim 8, further comprising:
calculating the amount the intermediate axis should be adjusted to obtain a predefined calibration angle based on said first (a) and second (b) angular value, and on basis thereof calibrating the intermediate axis.

10. The method according to claim 8, wherein the robot is moved to the second calibration position (B), by turning the rear axis 180 degrees and counter rotating the fore axis 180 degrees.

11. The method according to claim 8, wherein the robot includes six axes and said rear axis corresponds to the fourth axis (A4) of the six-axes robot, said intermediate axis corresponds to the fifth axis (A5) of the six-axes robot, and said fore axis corresponds to the sixth axis (A6) of the six-axes robot.

12. The method according to claim 1, wherein the robot comprises three successive axes including a rear, an intermediate and a fore axes, wherein the intermediate axis is arranged non-parallel to the rear and fore axis, the method further comprising:
selecting the intermediate and rear axis as the calibration axes and the fore axis as the measuring axis,
moving the robot to a first calibration position (C),
reading a first angular value (c) from the angle measuring member,
moving the robot to a second calibration position (D), including rotating the robot about the fore axis,
reading a second angular value (d) from the angle measuring member, and
calibrating the rear and intermediate axes based on said first (c) and second (d) angular value, and the measured reference direction.

13. The method according to claim 12, further comprising:
calculating the amount the rear and intermediate axes should be adjusted to obtain predefined calibration angles, based on said first (c) and second (d) angular value, and the measured reference direction, and on basis thereof calibrating the rear and intermediate axes.

14. The method according to claim 12, wherein the robot is moved to the second calibration position (D), by turning the fore axis 180°.

15. The method according to claim 12, wherein the intermediate axis is calibrated based on the difference between the first and second angular value divided by two ((|c|−|d|)/2).

16. The method according to claim 12, wherein the rear axis is calibrated based on the average value of the first and second angular value ((|c|+|d|)/2).

17. The method according to claim 8, wherein the robot includes six axes and said rear axis corresponds to the third axis (A3) of the six-axes robot, said intermediate axis corresponds to the fourth axis (A4) of the six-axes robot, and said fore axis corresponds to the fifth axis (A5) of the six-axes robot.

18. The method according to claim 1, wherein the robot comprises a tool attachment mounted rotatable about an tool axis and the angular measuring member is mounted on the tool attachment, the method further comprises:
before reading at least some of the angular values moving the robot about the tool axis so that the angular measuring member is brought into its measuring position.

19. The method according to claim 12, wherein the robot is moved to the first calibration position (C) by moving the intermediate axis 90 degrees from home position, counter rotate the tool axis 90 degrees and moving the fore axis 90 degrees and the robot is moved to the fourth calibration position (D) by turning the fore axis 180 degrees.

20. The method according to claim 12, wherein the robot includes six axes and said rear axis corresponds to the third axis (A3) of the six-axes robot, said intermediate axis corresponds to the fourth axis (A4) of the six-axes robot, and said fore axis corresponds to the fifth axis (A5) of the six-axes robot.

21. The method according to claim 18, wherein said tool axis corresponds to the sixth axis (A6) of the six-axes robot.

22. A computer program product, comprising:
a computer readable medium, and computer program instructions recorded on the computer readable medium and executable by a processor for performing a method for calibration of an industrial robot including measuring a reference direction, selecting at least one of a plurality of axes as a calibration axis and another of said axes as a measuring axis, moving the robot between at least two calibration positions, wherein the moving includes rotating the robot about the measuring axis, and the calibration positions are selected such that the direction of the calibration axis differs from the vertical line, reading angular values from the angle measuring member in said calibration positions, and calibrating the calibration axis based on said angular values and the measured reference direction.

23. (canceled)

24. A system for calibration of an industrial robot having a plurality of sections movably connected to each other for rotation about a plurality of movement axes, wherein an angle measuring member is mounted on the robot so that it measures angular changes of the axis or axes to be calibrated, relative to a vertical line, the system comprising:
a calibration module adapted to upon activation automatically calibrate at least one of said axis selected to be a calibration axis, wherein the calibration module comprises:
a robot control module, adapted to provide control signals to the robot moving the robot between at least two calibration positions, wherein the moving includes rotating the robot about a measuring axis, and
calculation means, adapted to receive and store measurements of a reference direction, to receive angular values from the angle measuring member in said calibration positions, and to calibrate the calibration axis based on said angular values and the stored reference direction.

25. The system according to claim 24, wherein the calculation means is adapted to calculate the amount the calibration axis should be adjusted to obtain a predefined calibration angle, based on said angular values measured in said calibration positions, and wherein said control module is adapted to provide control signals to the robot moving the robot in dependence of said calculated amount in order to calibrate said calibration axis.
